(19) United States
(12) Patent Application Publication
(10) Pub. No.: US 2005/0179920 A1
(43) Pub. Date: Aug. 18, 2005

(54) System and method for printing labels on-demand

(76) Inventors: Robert J. Bunsey, Huron, OH (US); Richard J. Bunsey, Cleveland, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/056,570

(22) Filed: Feb. 11, 2005

Related U.S. Application Data
(60) Provisional application No. 60/544,580, filed on Feb. 13, 2004.

(51) Int. Cl. G06F 15/00

(52) U.S. Cl. 358/1.12; 358/1.18

(57) ABSTRACT

The present invention relates to a system and method for printing labels on-demand in a manufacturing environment. During initialization, an association is made between a part being manufactured and the work station in which the part is made. The association is stored in a computer application. When a user desires to print a label, the user simply presses a user input device which generates a print request. The print request is interrogated to determine which port originated the print request. An indicator is presented to the operator indicating that a valid print request was received by the data storage device. The computer application searches for information related to the port that originated the print request. The data storage device transmits information from the computer application for printing on an associated printer.

### RELATED APPLICATION DATA

This application claims the benefit of U.S. Provisional Application No. 60/544,580, filed Feb. 13, 2004, which is incorporated by reference.

### BACKGROUND OF THE INVENTION

1. Technical Field

The present invention relates to a system and method for printing labels on-demand in a manufacturing environment and particularly to a system and method that permits the contents of the labels to be updated until just prior to printing in order to ensure that the information placed on the label is accurate and eliminates the mislabeling of parts and associated packaging.

2. Description of the Related Art

The automotive industry places an ever increasing demand on its suppliers for high quality parts. Quality is not only defined by the actual parts being manufactured and supplied by a particular supplier, but also on the contents of the labels that are used to identify the parts. Mislabeled parts have been a continuous source of quality problems for suppliers. This problem has grown in recent years due to the automotive industry's implementation of a number of “just-in-time” and “sequenced parts delivery” initiatives. These initiatives essentially require suppliers to deliver manufactured parts just-in-time for the parts to be used by the manufacturer and in the proper sequence set forth by the manufacturer. The goal of these initiatives was to maximize the manufacturer's use of floor space, reduce inventory levels and decrease the time consumer's wait for vehicles.

Proper labeling is an essential element of quality and a requirement for an effective sequencing program. In addition to internal supplier labeling requirements, the automobile manufacturer often requires specific labels to be affixed to the supplied parts and/or the container in which the parts are shipped. While the specific requirements for the contents of labels may vary greatly, typical sequenced parts programs require the part (or container which houses the part) to have a barcoded label along with some basic part information, such as a description, sequence number, customer part number, revision number, etc. In many instances, the information is subject to change by the manufacturer until just prior to packaging the part to be supplied.

Suppliers have implemented a variety of ways for manufactured parts to be labeled. In one method, the information technology department prints a batch of labels. The labels are then distributed by a production controller to the appropriate person that packages the part or device into the appropriate shipping package. A disadvantage associated with this method is that there is an overall loss of control over the labeling process. For example, it becomes difficult or impossible to accurately manage inventory and track production. Another disadvantage is that it is difficult to ensure that the right label is placed on the appropriate part or shipping container. Likewise, in many cases, the number of labels will not match the number of parts being manufactured. Therefore, there is a great likelihood of excess labels being produced which leads to expensive waste and possibly to the wrong label being used to identify a part.

Another popular method used by many manufacturers is the “kiosk” model. In the kiosk model, multiple personal computers located on the factory floor have a dedicated label printer or share a common label printer. Workers are required to interact with software, usually in the form of drop down menus to make a variety of selections (e.g., to identify the part numbers, select the quantity of labels needed, etc.). Problems associated with this method include susceptibility to human error, too many labels may be printed thereby resulting in increased waste, and an overall loss of control by management to accurately manage inventory and track production.

When manufacturing customers receive mislabeled parts there can be severe consequences. For instance, mislabeled parts make assembly lines less efficient. In some particular instances, mislabeled parts may even cause a complete shutdown of an assembly line. Such a consequence is particularly likely to occur when a new revision is made to a particular part and the revision is not reflected correctly on the label. An assembly line worker must take additional time to ensure that the correct part is being installed or the assembly line worker could just reject the entire lot of mislabeled parts out of hand. This lost efficiency leads to a significant loss of time and money to both the manufacturer and supplier of the mislabeled part. In addition, mislabeled parts reflect poorly on the supplier that supplied the part to the manufacturer and may result in the loss of a contract to supply parts to the manufacturer in the future.

Accordingly, there exists a need in the art for an improved system and method for properly labeling manufactured parts.

### SUMMARY OF THE INVENTION

The present invention relates to a system and method for printing labels on-demand by associating a particular work station with a user input device for generating a print request and a printer for printing an associated label.

In one embodiment, the present invention is directed to a system for generating a label, the system including: a user input device communicatively coupled to a data storage device, wherein the user input device is activated by an associated user action to generate a print request; the data storage device is capable of receiving the print request and the data storage device includes information related to the user input device and a printer, wherein the printer is communicatively coupled to the data storage device and the printer receives a least a portion of the information related to the user input device transmitted from the storage device and prints at least a portion of the received data on an associated label.

In another embodiment, the present invention is directed to a method for generating a label, the method including: generating a print request from a user input device communicatively coupled to a data storage device; transmitting the print request to the data storage device; receiving the print request at the data storage device; identifying data associated with the print request; transmitting at least a portion of the data associated with the print request to a printer; and printing at least a portion of the data associated with the print request on an associated label.

In another embodiment, the present invention is directed to a system for generating a label, the system including: a data storage device for storing data related to a printer and a user input device; the user input device is communicatively coupled to the data storage device, wherein the user input device is activated by an associated user action to transmit a print request to the data storage device; and a printer communicatively coupled to the data storage device, wherein the printer receives the data associated with the print request from the data storage device and prints at least a portion of the received data on an associated label.

In another embodiment, the present invention is directed to a method of associating peripheral devices with a work station, the method including: scanning a first barcode associated with a first peripheral device; enabling the first peripheral device; transmitting information related to the first peripheral device to a data storage device; scanning a second barcode associated with a second peripheral device; and transmitting information related to the second peripheral device to the data storage device; scanning a third barcode associated with a work station; and transmitting information related to the work station to the data storage device.

In another embodiment, the present invention is directed to a method for generating a label, the method including: generating a print request from a user input device communicatively coupled to a data storage device; interrogating the print request to determine an originating port for the print request; indicating to an associated user that the print request was received by the data storage device; searching a database for information related to the originating port; transmitting at least a portion of the information from the database to an associated printer and printing at least a portion of the information transmitted to the printer on an associated label.

The foregoing and other features of the invention are hereinafter fully described and particularly pointed out in the claims, the following description and the annexed drawings setting forth in detail one or more illustrative embodiments of the invention, such being indicative, however, of but one or a few of the various ways in which the principles of the invention may be employed.

### BRIEF DESCRIPTION OF THE DRAWINGS

FIG. 1 is an exemplary system diagram of a local area network in accordance with the present invention;

FIG. 2 is a block diagram of an exemplary server in accordance with the present invention;

FIG. 3 is a block diagram of an exemplary work station in accordance with the present invention; and

FIG. 4 is a flow chart illustrating the generation of a print request;

FIG. 5 is an exemplary part information database;

FIG. 6 is a flow chart illustrating associating a particular user input device and particular printer to a particular work station or part.

### DETAILED DESCRIPTION OF THE INVENTION

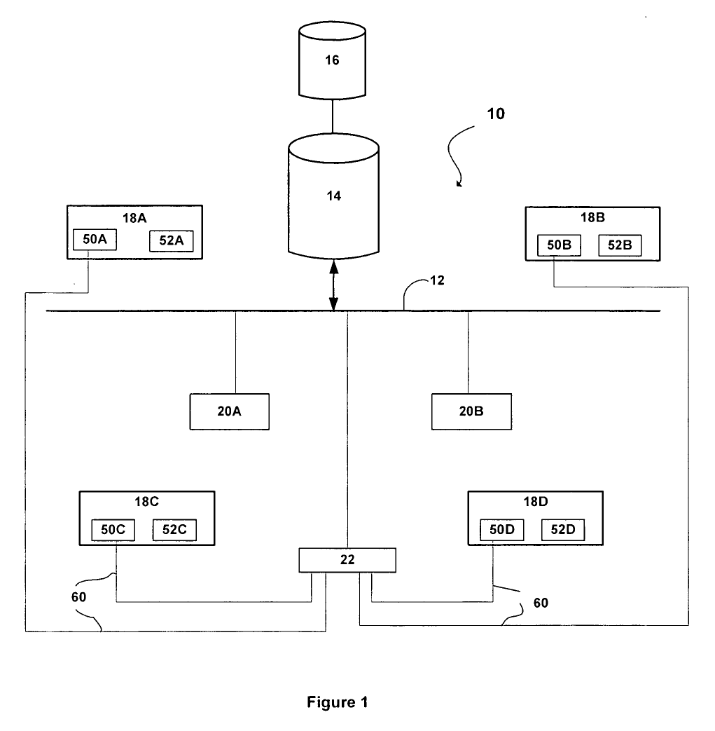

A local area network (LAN) 10 in accordance with the present invention is illustrated in FIG. 1. As shown, the LAN 10 includes a communications medium 12, a server 14, an electronic data interchange (EDI) and enterprise resource planning (ERP) server 16, one or more work stations 18A-18D, and one or more multiple wireless controllers 20A-20B.

The communications medium 12 can take the form of any medium that permits electronic devices to exchange information or data. For instance, the communications medium 12 may be a wired communications medium, such as Ethernet or a wireless communications medium, such as IEEE 802.11b or 802.11g. In addition, the communications medium 12 may also be a combination of wired and wireless communications mediums. Preferably, the communications medium 12 is a wired Ethernet communications medium. However, one of ordinary skill in the art will readily appreciate that any communications medium having the functionality described herein shall be deemed to be within the scope of the present invention.

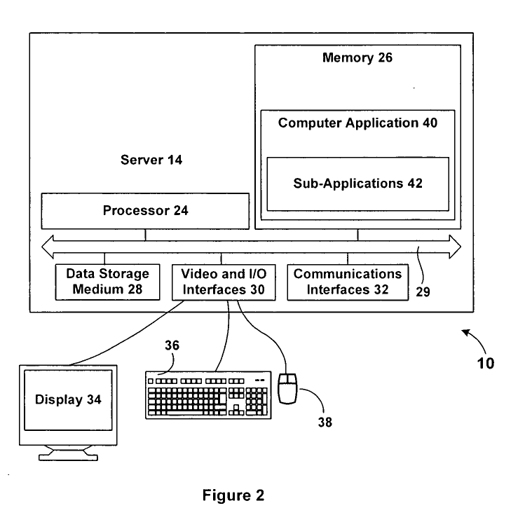

FIG. 2 illustrates a schematic block diagram of server 14. The server 14 (also known as a data storage device) generally includes a processor 24, a memory 26, a data storage medium 28, a local interface 29, video and input/output interfaces 30, and various communication interfaces 32. The server 14 may include optionally a display 34, a keyboard 36, and a user input device 38 (e.g., a computer mouse). The server 14 is capable of executing one or more computer applications 40 in accordance with aspects of the present invention. In one embodiment, computer application 40 includes a database for storing and organizing information related to a part or item being manufactured (e.g., a part to be supplied to an original equipment manufacturer (OEM) or an upper tier supplier) and communications software, which permit the values stored in the database to be transmitted to and updated by various local and remote devices. The computer application 40 may be logically associated with or call one or more additional computer applications or one or more sub-computer applications 42, which generally include compilations of executable code.

In one embodiment, the computer application 40, and/or the sub-applications 42 are embodied as one or more computer programs (e.g., one or more software applications including compilations of executable code). The computer program(s) can be stored on a data storage medium 28 or other computer readable medium, such as a magnetic or optical storage device (e.g., hard disk, CD-ROM, DVD-ROM, etc.).

To execute the computer application 40 and associated database and sub-applications 42, the server 14 can include one or more processors 24 used to execute instructions that carry out a specified logic routine(s). Preferably, the server 14 is based on a client-server architecture and may serve multiple clients. However, one of ordinary skill in the art will readily appreciate that any combination of computers having the functionality described herein shall be deemed to be within the scope of the present invention.

The server 14 may have a memory 26 for storing data, software, logic routine instructions, computer programs, files, operating system instructions, and the like. As illustrated in FIG. 2, the computer application 40 and sub-applications 42 can be stored in the memory 26. The memory 26 can comprise several devices and includes, for example, volatile and non-volatile memory components. Accordingly, the memory 26 can include, for example, random access memory (RAM), read only memory (ROM), hard disks, floppy disks, compact disks (e.g., CD ROM, DVD ROM, CD RW, etc.), tapes, and/or other memory components, plus associated drives and players for these memory types. The processor 24, memory 26 and the data storage medium 28 are coupled using a local interface 29. The local interface 29 can be, for example, a data bus with accompanying control bus, a network, or other subsystem.

The server 14 can have various video and input/output interfaces 30 as well as one or more communications interfaces 32. The interfaces 30 can be used to couple the server 14 to various peripherals, such as a display 34 (e.g., a CRT display, an LCD display, a plasma display, etc.), a keyboard 36, and a user input device 32. The communications interfaces 32 can be comprised of, for example, a modem, a network interface card, and/or a wireless network interface card. The communications interfaces 32 can enable the server 14 to transmit and receive data signals, voice signals, video signals, and the like via an external network, such as the Internet, a wide area network (WAN), a local area network (LAN), direct data link, or similar wired (e.g., Ethernet) or wireless system (e.g., 802.11b). Preferably, the system 10 has the capabilities for both a wired communications interface (e.g., Ethernet) and a wireless communications interface (e.g., 802.11(b)) to accomplish the functionality described herein. However, one of ordinary skill in the art will readily appreciate that a wireless communication medium and a wired communication medium may be used interchangeably to accomplish the functionality described herein and any such arrangement shall be deemed to be within the scope of the present invention.

The server 14 transmits and receives information or data to and from peripherals or devices located at or near one or more respective work stations 18A-18D, as illustrated in FIG. 1. As used herein, the phrase “work station” identifies a point in the manufacturing process wherein it is deemed desirable for a part (or item) to be identified with a label (e.g., when the part is ready to be inserted into a container; packaged for shipment; or for internal identification purposes).

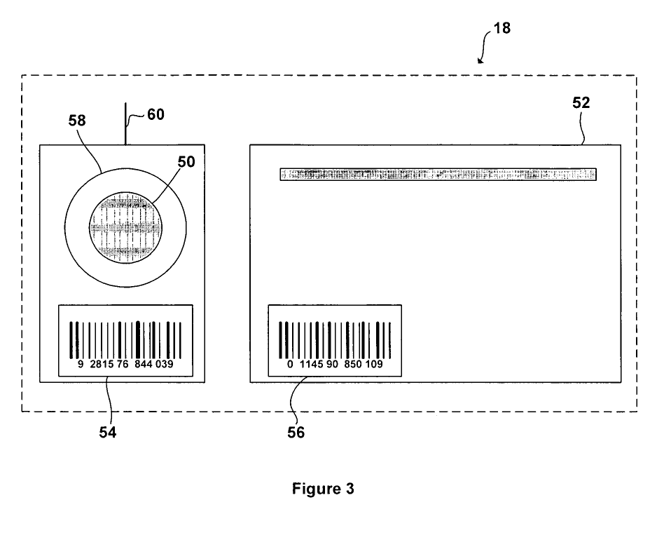

As shown in FIG. 1, each work station 18A-18D is associated with a respective work area wherein a part (or item) is undergoing a manufacturing process. An exemplary work station is depicted in FIG. 3. The work station 18 generally includes a user input device 50 and a printer 52. The user input device 50 may be any type of device that outputs a predetermined response upon user activation. In one embodiment, the user input device 50 is push-button switch. The printer 52 may be any type of printing device, including a barcode printer.

The user input device 50 and the printer 52 each may include an identifier. The identifier may take any form including a label, hardware identifiers embedded in the respective devices, radio frequency identification chips, etc. As described herein, the identifiers are in the form of a label located on the outer periphery of the device for identification purposes. Preferably, the identification of the user input device 50 and the printer 52 is accomplished through the use of barcode labels 54 and 56, respectively. The barcode labels 54 and 56 permit a supervisor (or other authorized personnel) to easily associate the user input device 50 and the printer 52 to a particular work station manufacturing a specific part. As discussed more fully below, barcode labels 54 and 56 may be scanned with a barcode scanner (not shown). Thus, the barcode labels 54 and 56 provide a convenient mechanism for association of the user input device 50 and the printer 52 with a particular work station 18 (or part being manufactured). One of ordinary skill in the art will readily appreciate that many other methods that may be used to associate a particular device with a specific work station 18. For example, a user may manually insert the identification of the devices associated with work station directly into the server 14 and computer application 40 through the keyboard 36, as illustrated in FIG. 2.

Preferably, the user input device 50 is a push-button switch further including an indication mechanism 58 in order to indicate to the operator or user when the user input device 50 has been depressed. For example, as shown in FIG. 3, the indication mechanism 58 may include a ring surrounding the user input device 50, which illuminates when the user imparts a sufficient amount of force on the user input device 50 to trigger the user input device 50 to change states. The indication mechanism 58 is provided in order to prevent the operator from depressing the user input device 50 multiple times because the operator is not sure if the user input device 50 was originally pressed. In addition, time delays may be programmed into the user input device 50. For example, once the user input device 50 is activated, the user input device is unable to generate another print request for a predetermined period of time. Thus, the indicator mechanism 58 serves to prevent material waste and provides additional inventory and production controls for management.

As shown in FIG. 1, the user input device 50 may be connected to the data storage device 14 by any means, including wired or wireless communications media, and communicate through any using any appropriate communications protocol (e.g., TCP/IP). Preferably, the user input device is connected to the data storage device 14 by an Ethernet data acquisition device (EDAD) 22 via a cable 60. The cable 60 contains two twisted pairs of wires capable of carrying 24 volts of electricity. When a user makes a print request, i.e., by imparting a sufficient force on the user input device 50 to change states, a circuit is defined which allows the voltage from a power supply associated with the EDAD 22 (or in a control panel associated with the EDAD 22) to travel through the closed user input device 50 and then back to the acquisition port of the EDAD 22 in which the user input device 50 is connected through the cable 60. The EDAD 22 senses the voltage on the input port associated with the print request and creates an Ethernet packet with the port number that detected the voltage. The Ethernet packet is transmitted through the communications medium 12 to server 14 and the computer application 40.

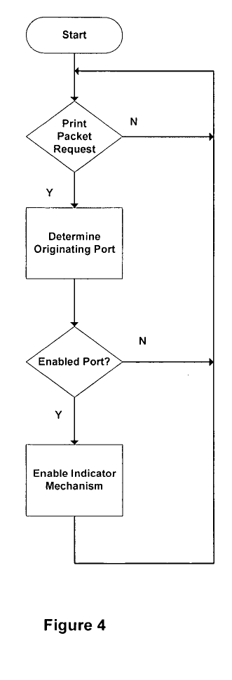

As shown in FIG. 4, computer application 40 continuously monitors (or listens) for the arrival of print request packets. Once such a packet is detected, the computer application 40 interrogates the data contained in the packet in order to determine which port originated the print request. While interrogation of the print request packet has been described as occurring in computer application 40, one of ordinary skill in the art will readily appreciate that interrogation of the print request packet may occur in hardware or in another computer application or sub-application or a combination of hardware and software.

The computer application 40 determines if the particular port (which is connected with a user input device 50) is in an “enabled” status. As discussed more fully below, a port is “enabled” if its associated user input device 50 is designated as “enabled” in the computer application 40 associated with the port (or user input device). If the port is “enabled,” the server 14 sends a command to the EDAD 22 via the communications medium 12 to output a voltage to the port in order to provide power to the indicator mechanism 58. In turn, the EDAD 22 transmits a 24 volt burst of direct current voltage for a short duration of time, which results in power being provided to the indicator mechanism 58. When power is provided to the indicator mechanism 58, the indicator mechanism 58 outputs an indication to the operator (e.g., light or sound), which informs the operator that the server 14 sensed the change in state of the user input device 50 and that the user input device 50 is properly “enabled.” Typically, the duration of time in which power is supplied to the indicator mechanism ranges from one to three seconds. Otherwise, if a print request packet is received when the port is disabled, the port will not respond to the print request (e.g., power will not be supplied to indicator mechanism 58).

If a print request is received from an “enabled” user input device, the server 14 through the computer application 40, searches a database (described below) for an internal cross-reference table to find the current association between the activated port, the associated printer 52 and the part being manufactured. Once the computer application 40 determines the part number associated with the activated user input device 50, the computer application 40 parses the data that will appear on the printed label. The computer application 40 then creates a data stream in the native language of the printer 52 and the server 14 transmits the data stream to the printer 52. Preferably, the server 14 transmits the data stream to wireless controller 20 via the communications medium 12. In turn, the wireless controller 20 (e.g., an 802.11b access point) transmits the data stream to the Internet Protocol (IP) address of the printer 52, which includes a wireless network interface card. It is preferable to use a wireless communications medium with printer 52 in order to logistically place the printer in the most convenient workspace for the operator.

The data stream transmitted to the printer 52 includes commands to format the label, (e.g., pertinent human readable data to print on the label such as part number and quantity, and other data which will print as one or more barcodes on the label). The printer 52 receives the label data stream and prints the label. One label is printed for each print request (i.e., activation of the user input device 50). In general, the total round trip duration from activation of the user input device 50 to the label being printed is approximately two to three seconds. Thus, the present invention provides an efficient and convenient system and method for printing labels while also allowing management to maintain control of the inventory and manufacturing processes.

While each work station 18 generally includes a user input device 50 and a printer 52, it may be advantageous, to integrate or combine the user input device 50 and printer 52 into a single unit (not shown).

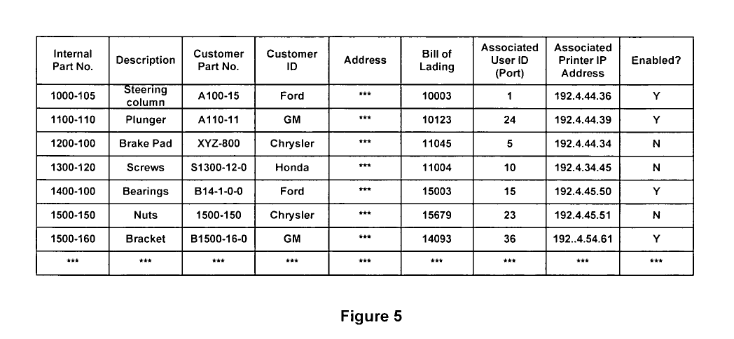

Initialization and data flow associated with the present invention will now be discussed. Referring to FIG. 5, a representative database 70 is shown. The database 70 is generally part of the computer application 40. However, to better describe the organization of the database 70, it has been given a separate reference numeral. The database 70 generally includes multiple columns (fields) and rows (records) organized by any of a variety of information. For purposes of illustration, the representative database 70 includes the following representative column (field) headings: Internal Part No., Description, Address, Customer Part Number, Bill of Lading Number, associated user input device (or port), associated printer IP address, status, etc. Additional data that may be contained in database 70 includes: Ship Date, Label Style, Quantity, Advance Shipping Notice Identification, Supplier Name, Supplier Address, Lot Number, etc. Each row (record) of the database 70 typically includes information related to a different part being manufactured in the location of the LAN 10.

Referring back to FIG. 1, the server 14 is communicatively coupled to an EDI and ERP server 16. While shown as a single server, the EDI and ERP functions may be separated and located in two separate servers or storage mediums. The EDI and ERP server 16 contains a master list of information necessary to process electronic requests from a variety of sources. In order to keep the information on the server 14 as accurate as possible, the server 14 may download information from the EDI and ERP server 16 manually at any time or automatically at predetermined intervals. Preferably, the server 14 downloads information from the EDI and ERP server 16 at least once a day. Updating the server 14 with such frequency ensures that any customer changes or modifications to a particular part or order (e.g., the number of parts ordered, the description of the part ordered, etc.) will be properly reflected in the database 70 prior to a label being printed.

The database 70 includes three fields, “Associated User Input Device,” “Printer IP Address” and “Status” which require user interaction to initialize and associate a particular part or work station 18 with a user input device 50 and a printer 52. These variables are set periodically, typically before a particular part is manufactured. The computer application 40 includes a set-up (or initialization) mode that associates such information with particular peripheral devices (e.g., user input device 50 and printer 52). One of ordinary skill in the art will readily appreciate that there are a number of ways to associate a particular peripheral device with a work station 18. For example, labels may be used, identification may occur in hardware by identifiers embedded in the respective devices, and/or radio frequency identification chips associated with a particular device may be used.

Preferably, a wireless optical barcode scanner (not shown) is used to associate a user input device 50 and printer 52 with a particular part in the database 70 during the set-up mode. As stated above, each user input device 50A-50D and printer 52A-52D includes a barcode label 54 and 56, respectively on the exterior of the device so that the device can be scanned by an optical barcode scanner. The optical barcode scanner is generally equipped with radio frequency communication capabilities that will allow the scanner to communicate throughout the application site (i.e., a factory, assembly line, or plant) via radio frequency through a wireless controller 20 to the server 14. One of ordinary skill in the art will readily appreciate the optical barcode scanner may also communicate with other network devices to accomplish the functionality discussed herein.

During the set-up (or initialization) mode, the computer application 40 transmits information to be displayed on the wireless barcode scanner in a menu format. An authorized person (e.g., a supervisor) is queried by the display of the wireless barcode scanner to “enable” or “disable” a user input device 50 and to associate a user input device 50 to a specific work station 18 (or part number) located in the database 70 of the computer application 40. The authorized person selects the appropriate menu choice by using a keyboard located on the handheld terminal to enter the number and then presses the “enter” key.

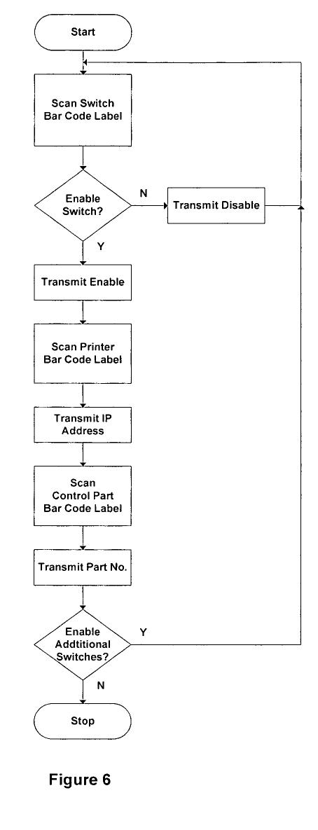

Referring to FIG. 6, during the set-up (or initialization) mode, an authorized person scans the barcode 54 associated with a particular user input device with a wireless barcode scanner, a screen is displayed querying the operator as to whether the user input device should be “enable” or “disable.” If the user selects “disable,” computer application 40 receives and stores a “disable” indication for the particular port and the process continues by scanning another barcode 54 associated with another user input device 50. If the user desires to “enable” a user input device 50, an “enable” indication is transmitted to the computer application 40 and stored in the database 70. The user is then queried to scan the barcode label 56 associated with the printer 52 and the control label associated with a part undergoing the manufacturing process (not shown). After each of these items is scanned, information related to the scanned label is transmitted to the server 14 and stored in database 70 associated with the computer application 40.

The barcode scanner transmits the information in the format of a suitable communications protocol (e.g., a TCP/IP packet) over the air to the wireless controller 20 (e.g., access point). The wireless controller 20 acts as a bridge between the “air” or wireless network and the wired network. The wireless controller 20 in which a particular barcode scanner transmits data will typically depend upon the geographical location of the barcode scanner in relation to the nearest wireless controller 20. However, one of ordinary skill in the art will readily appreciate that other parameters, such as response time and signal strength may be used to determine which wireless controller 20 receives information transmitted by the wireless barcode scanner. The controller 20, in turn, transfers the identification information to the server 14 where the information is processed and associated with a particular part or parts by computer application 40 and associated database 70.

After the initial work station is set-up (or initialized), any time the operator desires to print a label, the operator simply changes the state of the user input device 50. As stated above, changing the state of the user input device 50 generates a print request that is transferred to EDAD 22. The EDAD 22 transmits the print request to the server computer application 40 on the server 14. If the print request is valid, the indicator mechanism 58 is powered to provide an indication to the user that the user input device 50 was properly activated. The computer application 40 retrieves information associated with the print request, including the IP address of the printer 52 in which the information is to be sent. The server 14 transmits the information to the wireless controller 20, which in turn, transmits at least a portion of the data to the printer 52 through a wireless communication medium (e.g., 802.11b). A label is then printed to identify the part being manufactured at the work station 18.

Although the invention has been shown and described with respect to a certain preferred embodiment or embodiments, it is obvious that equivalent alterations and modifications will occur to others skilled in the art upon the reading and understanding of this specification and the annexed drawings. In particular, with regard to the various functions performed by the above described integers (components, assemblies, devices, compositions, etc.), the terms (including a reference to a “means”) used to describe such integers are intended to correspond, unless otherwise indicated, to any integer which performs the specified function of the described integer (i.e., that is functionally equivalent), even though not structurally equivalent to the disclosed structure which performs the function in the herein illustrated exemplary embodiment or embodiments of the invention. In addition, while a particular feature of the invention may have been described above with respect to only one of several illustrated embodiments, such feature may be combined with one or more other features of the other embodiments, as may be desired and advantageous for any given or particular application.

1. A system for generating a label, the system comprising:
a user input device communicatively coupled to a data storage device, wherein the user input device is activated by an associated user action to generate a print request;
the data storage device is capable of receiving the print request and the data storage device includes information related to the user input device and a printer, wherein the printer is communicatively coupled to the data storage device and the printer receives a least a portion of the information from the storage device and prints some of the received data on an associated label.

2. The system of claim 1, wherein the data storage device is a computer hard drive.

3. The system of claim 1, wherein the data storage device is a server.

4. The system of claim 1, wherein the user input device further includes an indicator mechanism for providing an indication that the user input device has changed states.

5. The system of claim 1, wherein the user input device is a push-button switch.

6. The system of claim 5, wherein the switch further includes an indicator mechanism for providing an indication that the switch has changed states.

7. The system of claim 1, wherein the print request includes a packet containing information related to the user input device which originated the print request.

8. The system of claim 1, wherein the received data is transmitted through air to the printer.

9. System of claim 8, wherein the received data further includes a part number.

10. The system of claim 8, wherein the received data further includes a barcode.
The system of claim 1, wherein the user input device and printer are integral.

12. The system of claim 1, wherein the data storage device receives periodic updates of information from an electronic data interchanger server.

13. A method for generating a label, the method comprising:
generating a print request from a user input device communicatively coupled to a data storage device;
transmitting the print request to the data storage device;
receiving the print request at the data storage device;
identifying data associated with the print request;
transmitting at least a portion of the data associated with the print request to a printer;
printing at least a portion of the data associated with the print request on an associated label.

14. The method of claim 13, further comprising illuminating an indicator mechanism to indicate that the print request was generated.

15. The method of claim 13, wherein the print request is transmitted to the data storage device through a TCP/IP packet.

16. The method of claim 13, wherein data associated with the print request is transmitted through air.

17. A system for generating a label, the system comprising:
a data storage device for storing data related to a printer and a user input device;
the user input device is communicatively coupled to the data storage device, wherein the user input device is activated by an associated user action to transmit a print request to the data storage device;
a printer communicatively coupled to the data storage device, wherein the printer receives the data associated with the print request from the data storage device and prints at least a portion of the received data on an associated label.

18. The system of claim 17, wherein the data storage device is a computer hard drive.

19. The system of claim 17, wherein the data storage device is a server.

20. The system of claim 17, wherein the user input device further includes an indicator mechanism for providing an indication that the user input device has changed states.

21. The system of claim 17, wherein the user input device is a push-button switch.

22. The system of claim 21, wherein the switch further includes an indicator mechanism for providing an indication that the user input device has changed states.

23. The system of claim 17, wherein the print request includes a packet containing information related to the user input device which originated the print request.

24. The system of claim 17, wherein the received data is transmitted through air to the printer.

25. The system of claim 24, wherein the received data further includes a part number.

26. The system of claim 24, wherein the received data further includes a barcode to be displayed on an associated label.

27. The system of claim 17, wherein the user input device and printer are integral.

28. The system of claim 17, wherein the data storage device receives periodic update of information from an electronic data interchange server.

29. A method of associating peripheral devices with a work station, the method comprising:
scanning a first barcode associated with a first peripheral device;
enabling the first peripheral device; transmitting information related to the first peripheral device to a data storage device; scanning a second barcode associated with a second peripheral device;
transmitting information related to the second peripheral device to the data storage device; scanning a third barcode associated with a work station; and transmitting information related to the work station to the data storage device.

30. The method of claim 29, wherein the transmitted information is transmitted to the data storage device through air.

31. The method of claim 30, wherein the transmitted information is transmitted in the form of a TCP/IP packet to the data storage device.

32. A method for generating a label, the method comprising:
generating a print request from a user input device communicatively coupled to a data storage device;
interrogating the print request to determine an originating port for the print request;
indicating to an associated user that the print request was received by the data storage device;
searching a database for information related to the originating port;
transmitting at least a portion of the information from the database to an associated printer
printing at least a portion of the information transmitted to the printer on an associated label.
